(19) United States
(12) Patent Application Publication
(10) Pub. No.: US 2019/0197309 A1
(43) Pub. Date: Jun. 27, 2019

(54) METHOD FOR ENTERING TEXT BASED ON IMAGE

(71) Applicant: ZhongAn Information Technology Service Co., Ltd., Shenzhen (CN)

(72) Inventors: Haiyan XU, Shenzhen (CN); Bo FENG, Shenzhen (CN); Hao YUAN, Shenzhen (CN); Gufei SUN, Shenzhen (CN)

(21) Appl. No.: 16/288,459

(22) Filed: Feb. 28, 2019

Related U.S. Application Data
(63) Continuation of application No. PCT/CN2018/116414, filed on Nov. 20, 2018.

(30) Foreign Application Priority Data
Nov. 21, 2017 (CN) 201711166037.1

(51) Int. Cl. G06K 9/00; G06K 9/32; G06F 17/24; G06K 9/62; G06T 7/70; G06F 17/21

(52) U.S. Cl. CPC G06K 9/00469; G06K 9/325; G06F 17/24; G06K 9/6261; G06T 2207/30176; G06T 7/70; G06F 17/212; G06K 2209/01; G06K 9/6262

(57) ABSTRACT

The present invention provides a method for entering text based on an image. The method includes a recognition parameter, corresponding to at least one region in an image, is acquired, the recognition parameter includes text contents recognized from the at least one region and location information associated with the at least one region. An entry location is selected in an entry page, and the following steps are performed: a parameter value, shared by a plurality of tag pages, is acquired; and according to the parameter value shared by the plurality of tag pages, a display page is automatically located to a region corresponding to the selected entry location. The parameter value shared by the plurality of tab pages comprises location information corresponding to the selected entry location. Based on the location information corresponding to the selected entry location and the recognition parameter, text contents to be entered are determined.

### CROSS-REFERENCE TO ASSOCIATED APPLICATIONS

This application is a continuation of International Application No. PCT/CN2018/116414 filed on Nov. 20, 2018, which claims priority to Chinese patent application No. 201711166037.1 filed on Nov. 21, 2017. Both applications are incorporated herein by reference in their entireties.

### TECHNICAL FIELD

Embodiments of the present invention relate to the field of text entry technologies, in particular to a method for entering text based on an image.

### BACKGROUND

Entering bills, tables, documents and more, is an important part of current digital management of paper information. The OCR (Optical Character Recognition) technology is a kind of computer entry technology, converting text of various bills, newspapers, books, manuscripts and other printed materials into image information by an optical entry manner such as scanning, and then converting the image information into text available for computer entry by a character recognition technology. As one of main manners to convert paper documents into text available for computer entry, the OCR technology may be applied to fields of entry and processing of bank bills, archive files and materials including a large amount of text. At present, a processing speed may reach 60-80 bills per minute, a recognition rate of a passbook has reached more than 85%, a recognition rate of a deposit receipt and a voucher has reached more than 90%. Due to the recognition rate of more than 85%, the number of data-entry clerks may be decreased by 80%, workloads of operators may be reduced, and duplication efforts may be reduced. However, since 100% accurate recognition has not been achieved, the data-entry clerk still have to manually enter apart of text content by referring to the paper text, and manually review the parts of content recognized.

Therefore, a method for entering text based on an image, by which fast enter speed of entering can be achieved, is badly needed.

### SUMMARY

In response to the above problems, the present invention proposes a method for entering text based on an image.

According to an aspect of the embodiments of the present invention, a method for entering text based on an image is provided. The method includes: acquiring a recognition parameter corresponding to at least one region in an image, the recognition parameter comprising text contents recognized from the at least one region and location information associated with the at least one region; selecting an entry location in an entry page and acquiring location information corresponding to a selected entry location; and determining text contents to be entered, based on the location information corresponding to the selected entry location and the recognition parameter.

In an embodiment, the acquiring location information corresponding to a selected entry location includes: acquiring a parameter value shared by a plurality of tag pages; and automatically locating, according to the parameter value shared by the plurality of tag pages, a display page to a region corresponding to the selected entry location; wherein the parameter value shared by the plurality of tab pages comprises location information corresponding to the selected entry location. In an embodiment, the automatically locating, according to the parameter value shared by the plurality of tag pages, a display page to a region corresponding to the selected entry location includes: zooming in on the region corresponding to the selected entry location.

In an embodiment, the acquiring a recognition parameter corresponding to at least one region in an image includes: dividing the image into regions automatically and recognizing text contents in the regions automatically divided.

In an embodiment, the recognizing text contents in the regions automatically divided includes: recognizing text contents in the regions automatically divided by using an OCR technology.

In an embodiment, the recognizing text contents in the regions automatically divided includes: scoring the text contents recognized to identify recognition accuracy.

According to another aspect of the present invention, a device for entering text based on an image is provided. The device includes: an acquiring recognition parameter unit, adapted to acquire a recognition parameter corresponding to at least one region in an image, the recognition parameter comprises text contents recognized from the at least one region and location information associated with the at least one region; a selecting and entering linkage unit, adapted to select an entry location in an entry page and acquire location information corresponding to a selected entry location; and, a determining text contents unit, adapted to determine text contents to be entered, based on the location information corresponding to the selected entry location and the recognition parameter.

In an embodiment, the selecting and entering linkage unit is further adapted to: acquire a parameter value shared by a plurality of tag pages; and automatically locate, according to the parameter value shared by the plurality of tag pages, a display page to a region corresponding to the selected entry location; wherein the parameter value shared by the plurality of tab pages comprises location information corresponding to the selected entry location.

In an embodiment, the selecting and entering linkage unit includes a zooming image unit; the zooming image unit is adapted to zoom in on the region corresponding to the selected entry location.

In an embodiment, the acquiring recognition parameter unit includes a dividing image and recognizing unit, the dividing image and recognizing unit is adapted to: divide the image into regions automatically and recognize text contents in the regions automatically divided.

In an embodiment, the dividing image and recognizing unit is further adapted to recognize text contents in the regions automatically divided by using an OCR technology.

In an embodiment, the dividing image and recognizing unit is further adapted to score the text contents recognized to identify recognition accuracy.

According to another aspect of the present invention, a device for entering text based on an image is provided. The device includes: a memory, a processor, and a computer program stored in the memory and executed by the processor, wherein when the computer program is executed by the processor, the processor implements the following steps: acquiring a recognition parameter corresponding to at least one region in an image, the recognition parameter comprising text contents recognized from the at least one region and location information associated with the at least one region; selecting an entry location in an entry page and acquiring location information corresponding to a selected entry location; and determining text contents to be entered, based on the location information corresponding to the selected entry location and the recognition parameter.

In an embodiment, when implementing the step of acquiring location information corresponding to a selected entry location, the processor specifically implements the following steps: acquiring a parameter value shared by a plurality of tag pages; and automatically locating, according to the parameter value shared by the plurality of tag pages, a display page to a region corresponding to the selected entry location; the parameter value shared by the plurality of tab pages comprises location information corresponding to the selected entry location.

In an embodiment, when implementing the step of automatically locating, according to the parameter value shared by the plurality of tag pages, a display page to a region corresponding to the selected entry location, the processor specifically implements the following step: zooming in on the region corresponding to the selected entry location.

In an embodiment, when implementing the step of acquiring a recognition parameter corresponding to at least one region in an image, the processor specifically implements the following step: dividing the image into regions automatically and recognizing text contents in the regions automatically divided.

In an embodiment, when implementing the step of recognizing text contents in the regions automatically divided, the processor specifically implements the following step: recognizing text contents in the regions automatically divided by using an OCR technology.

In an embodiment, when implementing the step of recognizing text contents in the regions automatically divided, the processor specifically implements the following step: scoring the text contents recognized to identify recognition accuracy.

According to another aspect of the present invention, a computer readable storage medium is provided, the computer readable storage medium storing an executable instruction executed by a processor; when the processor executes executable instruction, the processor executes a method described above.

The beneficial technical effects of the present invention are as follows:

The method for entering text based on an image provided by embodiments of the present invention makes it possible to efficiently perform an interactive operation of fast entry of forms, tickets, documents and so on. When a data-entry clerk enters text in a selected entry box, since an image is automatically placed to a corresponding location and contents of the uploaded image is enlarged, the data-entry clerk does not need to manually drag the image, to accomplish the entry, the time of the entry according the image may be greatly saved, and the entry efficiency may be improved. In addition, by identifying text contents, recognized through the OCR technology, with a recognition accuracy, users can quickly check according to the recognition accuracy directly when wants to perform a review, so the review time can be effectively reduced and the entry efficiency can be greatly improved.

### BRIEF DESCRIPTION OF DRAWINGS

FIG. 1 is a schematic flowchart of a method for entering text based on an image according to an embodiment of the present invention.

FIG. 2 is a schematic flowchart of a method for realizing bill text entry according to an embodiment of the present invention.

FIG. 3 is an example of a bill image displayed on a display page according to an embodiment of the present invention.

FIG. 4 is a schematic diagram of an entry page according to an embodiment of the present invention.

FIG. 5 is a schematic diagram of a device for entering text based on an image according to an embodiment of the present invention.

FIG. 6 is a schematic diagram of a device for entering text based on an image according to another embodiment of the present invention.

### DETAILED DESCRIPTION

In the detailed description of the following preferred embodiments, the reference is made to the accompanying drawings that form a part of the present invention. The accompanying drawings illustrate, by way of examples, specific embodiments that may achieve the present invention. The exemplary embodiments are not intended to be exhaustive of all embodiments in accordance with the present invention. It should be understood that other embodiments may be utilized and structural or logical modifications may be made without departing from the scope of the present invention. Therefore, the following detailed description is not restrictive, and the scope of the present invention is limited by the appended claims.

The present invention is described in detail below with reference to the accompanying drawings.

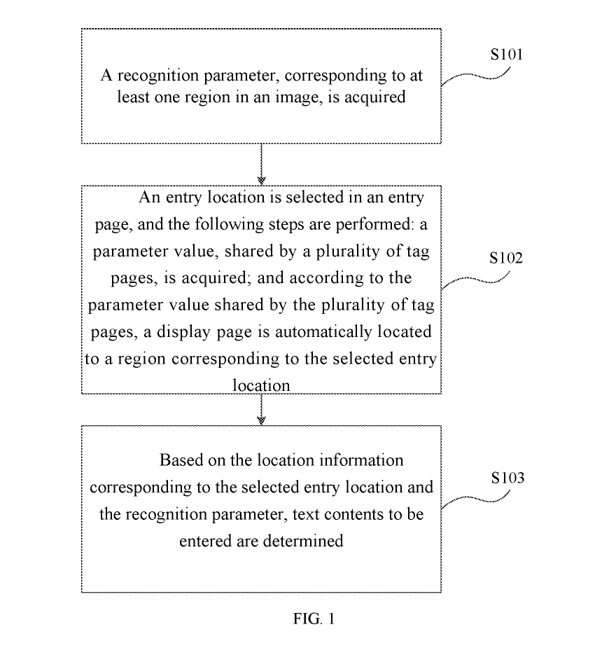

FIG. 1 is a schematic flowchart of a method for entering text based on an image according to an embodiment of the present invention.

The present invention provides a method for entering text based on an image, and the method includes the following steps.

Step S101: a recognition parameter, corresponding to at least one region in an image, is acquired, the recognition parameter includes text contents recognized from the at least one region and location information associated with the at least one region.

Step S102: an entry location is selected in an entry page, and the following steps are performed: a parameter value, shared by a plurality of tag pages, is acquired; and according to the parameter value shared by the plurality of tag pages, a display page is automatically located to a region corresponding to the selected entry location. The parameter value shared by the plurality of tab pages comprises location information corresponding to the selected entry location.

Step S103: based on the location information corresponding to the selected entry location and the recognition parameter, text contents to be entered are determined.

It should be understood that the image targeted by the method includes multiple types of paper documents such as bills, tables, documents, and so on. The image is not limited to a specific type of paper documents. The method for entering text based on an image, according to embodiments of the present invention, is further elaborated below by taking the bill as an example.

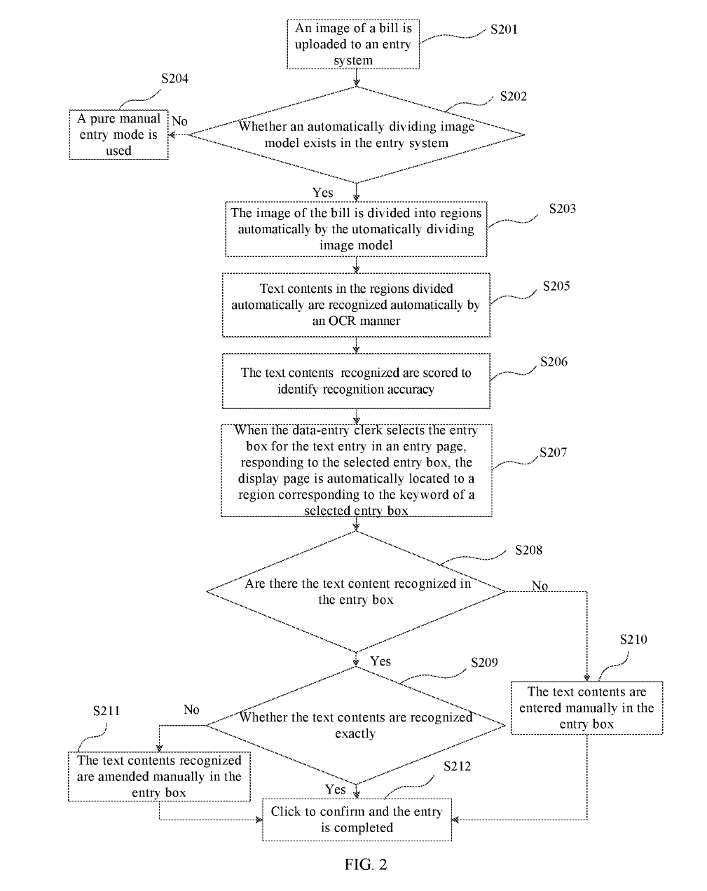

FIG. 2 is a schematic flowchart of a method for realizing bill text entry according to an embodiment of the present invention.

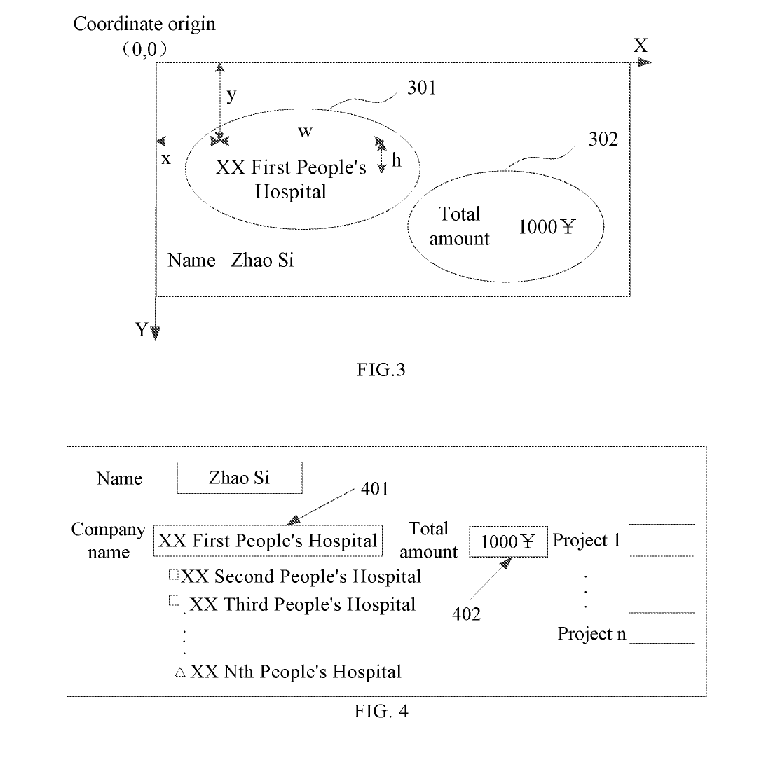

An implementation process of the bill text entry will be described in detail below with reference to FIG. 2, FIG. 3 and FIG. 4.

Step S201: an image of a bill is uploaded to an entry system.

In this step, users need to upload a required bill to an entry system by any suitable means such as scanning. When the bill is not uploaded to the entry system correctly, according to the type of the uploading error, the entry system will provide a notice that the bill needs to be re-uploaded.

Step S202: it is judged whether an automatically dividing image model exists in the entry system.

When an automatically dividing image model exists in the entry system, Step S203 is executed, otherwise Step S204 is executed.

Step S203: the image of the bill is divided into regions automatically by the automatically dividing image model, and location information of the regions is acquired.

The automatically dividing image model in this embodiment is a model based on a machine learning algorithm, and an image is divided automatically into regions by determining a location of a keyword in the image. It should be understood that the image may also be divided automatically into regions by any suitable models and in any suitable manners.

Step S204: a pure manual entry mode is used.

Step S205: text contents in the regions divided automatically are recognized automatically by using an OCR technology.

It should be understood that text contents in the regions, have been divided automatically, may be recognized automatically by other any suitable manners.

Step S206: the text contents recognized are scored to identify recognition accuracy. A high score is a recognition item with high recognition accuracy by a system default, and a low score is a recognition item with low recognition accuracy by the system default. For example, in this embodiment, the recognition item with a score of 85 or higher is regarded as a recognition item with the high recognition accuracy, and a small rectangular frame (as shown in FIG. 4) is added on aside of a drop-down box option at an entry location (an entry box in this embodiment). The recognition item with a score lower than 85 is considered to be a recognition item with the low recognition accuracy, and a small triangle (as shown in FIG. 4) is added on the side of the drop-down box option at the entry location (the entry box in this embodiment). In other embodiments, as for the text contents recognized with different scores, the recognition accuracy is distinguished by labeling different colors in a corresponding drop-down box options.

It should be understood that purposes of identifying recognition accuracy is to facilitate a rapid view of the data-entry clerk, and the recognition item with high accuracy can be quickly confirmed to complete the entry, and a key point may be focused on the recognition item with the low recognition accuracy, and a problem of recognition inaccuracy may be corrected in time, thus the review time may be shortened. A scoring system is only one of manners to identify the recognition accuracy, and setting of a score level is not unique. Those skilled in the art may identify the recognition accuracy by other suitable manners.

Step S207: when the data-entry clerk selects the entry box for the text entry in an entry page, responding to the selected entry box, the display page is automatically located to a region corresponding to the keyword of a selected entry box. Specifically, as shown in FIG. 4, when the data-entry clerk places a mouse on the entry page to a place 401 of “XX First People's Hospital”, content of “XX First People's Hospital” in a region 301 of FIG. 3 will be displayed in the middle of a display page, and the content may be automatically enlarged to an appropriate size, when necessary, the content may also be manually adjusted by a zoom tool. Similarly, when the data-entry clerk places the mouse on the entry page to a place 402 of “total amount” which is shown in FIG. 4, content of “total amount” in a region of 302 of FIG. 3 and a value “1000¥” corresponding to the “total amount” will be displayed in the middle of the display page, and the content may also be automatically enlarged to an appropriate size, when necessary, the content may also be manually adjusted by the zoom tool. Similarly, the same functions described above may be achieved when the mouse is placed in any other entry box of the display page.

In an implementation process of this embodiment, browser cross-tab communication is adopted. Specifically, the browser window is used to monitor changes of Local Storage. A value in the Local Storage may be shared among different tabs, and linkage between the entry page and the display page is implemented according to characteristic of a storage event, and the specific implementation manner is as follows.

Firstly, location information of the region automatically divided from the image of the bill in Step S203 is represented by a coordinate point (x, y, w, h), as shown in FIG. 3, x represents transverse coordinate points of the region which has been already automatically divided in the image of the bill, y represents longitudinal coordinate points of the region which has been already automatically divided in the image of the bill, w represents the width of the region which has been already automatically divided in a x-axis direction, and h represents the height of the region which has been already automatically divided in a y-axis direction.

Then, an initialization process is carried out, and the coordinate point of the location information, of the region which has been already automatically divided, and the text contents, recognized by the region which has been already automatically divided in the Step S205, are added and stored in the local storage.

Subsequently, a mouse sliding event is monitored. When a user slides the mouse from a current location of the entry box to a location of the entry box that needs to be entered, a keyword corresponding to the entry box is obtained, and a coordinate point of a new location information corresponding to the keyword and text contents corresponding to the coordinate point are used to update a corresponding value in the Local Storage.

Then, changes of the Local Storage are monitored at the display page, and according to the corresponding value updated by a monitored storage event in the Local Storage, the image is translated to a corresponding region in the display page and the corresponding region is enlarged.

It should be understood that the browser cross-tab communication may also be achieved by other schemes such as Broadcast Channel, Cookie, Web Socket and so on. However, the Local Storage has better compatibility and a longer life cycle than the Broadcast Channel. Compared with the Cookies, when, because there is no event notification that the cookie is changed, business logic is implemented only by adopting repeated dirty checking, and the businesses logic are only used in the same domain. After the Cookies are polluted, content of request header of AJAX will be additionally added, and a storage space which is small is limited to 4K. The Web Socket is suitable for small projects, backend servers are required to maintain connections and subsequent information forwarding, which occupy more server resources. Therefore, in this embodiment, the Local Storage is used to achieve the browser cross-tab communication.

Step S208: when there are the text contents, which have been recognized, in the entry box placed by the mouse at the entry page shown in FIG. 4, Step S209 is executed; otherwise Step S210 is executed;

Step S209: it is judged whether the text contents are recognized exactly; when the text contents are recognized exactly, Step S212 is executed; otherwise Step S211 is executed;

Step S210: in the entry box, the text contents are entered manually according to the content displayed on the display page, and then Step S212 is executed;

Step S211: the text contents recognized are amended manually in the entry box;

Step S212: click to confirm and the entry is completed.

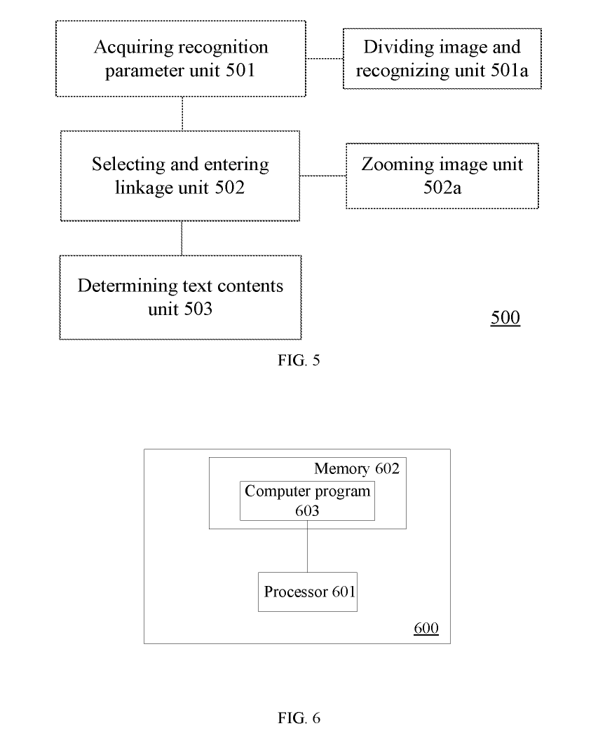

In addition, FIG. 5 shows a schematic diagram of a device 500 for entering text based on an image according to an embodiment of the present invention. The present invention also provides a device 500 for entering text based on an image as shown in FIG. 5; the device 500 includes an acquiring recognition parameter unit 501, a selecting and entering linkage unit 502, and a determining text contents unit 503. Specifically, the acquiring recognition parameter unit 501 is adapted to acquire a recognition parameter corresponding to at least one region in an image, the recognition parameter comprises text contents recognized from the at least one region and location information associated with the at least one region. According an entry location selected in an entry page, the selecting and entering linkage unit 502 is adapted to perform the following steps: acquire a parameter value shared by a plurality of tag pages, and according to the parameter value shared by the plurality of tag pages, automatically locates a display page to a region corresponding to the selected entry location. The parameter value shared by the plurality of tab pages comprises location information corresponding to the selected entry location. The determining text contents unit 503 is adapted to determine text contents to be entered, based on the location information corresponding to the selected entry location and the recognition parameter.

Further, in an embodiment, the acquiring recognition parameter unit 501 includes a dividing image and recognizing unit 501a, the dividing image and recognizing unit 501a is adapted to divide the image into regions automatically and recognize text contents in the regions. In an embodiment, the dividing image and recognizing unit 501a is further adapted to recognize text contents in the regions by using an OCR technology. In another embodiment, the dividing image and recognizing unit 501a is further adapted to score the text content recognized to identify recognition accuracy.

Further, in an embodiment, the selecting and entering linkage unit 502 includes a zooming image unit 502a; the zooming image unit 502a is adapted to zoom in on the region corresponding to the selected entry location.

FIG. 6 shows a schematic diagram of a device 600 for entering text based on an image according to another embodiment of the present invention. As shown in FIG. 6, the device 600 includes a memory 602, a processor 601, and a computer program 603 stored in the memory 602 and executed by the processor 601; when the computer program 603 is executed by the processor 601, the processor 601 implements anyone of the methods for entering text based on an image according to embodiments described above.

A flow of the text entry method in FIG. 1 and FIG. 2 also represents machine readable instructions, including a program executed by a processor. The program may be embodied in software stored in a tangible computer readable medium such as a CD-ROM, a floppy disk, a hard disk, a digital versatile disk (DVD), a Blu-ray disk or other form of memory. Alternatively, some or all steps of the methods in FIG. 1 may be implemented by using any combination of an application specific integrated circuit (ASIC), a programmable logic device (PLD), a field programmable logic device (EPLD), a discrete logic, hardware, firmware, and so on. In addition, although the flowchart shown in FIG. 1 describes the method for entering text based on an image, the steps in the text method for entering text based on an image may be modified, deleted, or merged.

As described above, an example process of FIG. 1 may be implemented by using coded instructions, such as computer readable instructions, the coded instructions are stored in the tangible computer readable medium, such as the hard disk, a flash memory, a read only memory (ROM), a compact disk (CD), the digital versatile disc (DVD), a cache, a random access memory (RAM), and/or any other storage medium on which information may be stored for any time (e.g., for a long time, permanent, transient situation, temporary buffering, and/or caching of information).

As used herein, the term of the tangible computer readable medium is expressly defined to include any type of a computer readable stored signal. Additionally or alternatively, the example process of FIG. 1 may be implemented with the encoded instructions (such as the computer readable instructions), the encoded instructions are stored in a non-transitory computer readable medium such as the hard disk, flash memory, read only memory, optical disk, digital versatile disk, cache, random access memory and/or any other storage medium on which the information may be stored for any time (e.g., for a long time, permanent, transient situation, temporary buffering, and/or caching of information).

Although the present invention has been described with reference to the specific examples, which are only intended to be illustrative and not limiting the present invention, it will be apparent to those skilled in the art that changes, additions or deletions may be made to the disclosed embodiments without departing from the spirit and scope of the present invention.

What is claimed is:

1. A method for entering text based on an image, comprising:
acquiring a recognition parameter corresponding to at least one region in an image, the recognition parameter comprising text contents recognized from the at least one region and location information associated with the at least one region;
selecting an entry location in an entry page and acquiring location information corresponding to a selected entry location; and
determining text contents to be entered, based on the location information corresponding to the selected entry location and the recognition parameter.

2. The method for entering text based on an image of claim 1, wherein the acquiring location information corresponding to a selected entry location comprises:
acquiring a parameter value shared by a plurality of tag pages; and
automatically locating, according to the parameter value shared by the plurality of tag pages, a display page to a region corresponding to the selected entry location;
wherein the parameter value shared by the plurality of tab pages comprises location information corresponding to the selected entry location.

3. The method for entering text based on an image of claim 2, wherein the automatically locating, according to the parameter value shared by the plurality of tag pages, a display page to a region corresponding to the selected entry location comprises:
zooming in on the region corresponding to the selected entry location.

4. The method for entering text based on an image of claim 1, wherein the acquiring a recognition parameter corresponding to at least one region in an image comprises: dividing the image into regions automatically and recognizing text contents in the regions automatically divided.

5. The method for entering text based on an image of claim 4, wherein the recognizing text contents in the regions automatically divided comprises: recognizing text contents in the regions automatically divided by using an OCR technology.

6. The method for entering text based on an image of claim 4, wherein the recognizing text contents in the regions automatically divided comprises: scoring the text contents recognized to identify recognition accuracy.

7. A device for entering text based on an image, comprising: a memory, a processor, and a computer program stored in the memory and executed by the processor, wherein when the computer program is executed by the processor, the processor implements the following steps:
acquiring a recognition parameter corresponding to at least one region in an image, the recognition parameter comprising text contents recognized from the at least one region and location information associated with the at least one region;
selecting an entry location in an entry page and acquiring location information corresponding to a selected entry location; and
determining text contents to be entered, based on the location information corresponding to the selected entry location and the recognition parameter.

8. The device for entering text based on an image of claim 7, wherein when implementing the step of acquiring location information corresponding to a selected entry location, the processor specifically implements the following steps:
acquiring a parameter value shared by a plurality of tag pages; and
automatically locating, according to the parameter value shared by the plurality of tag pages, a display page to a region corresponding to the selected entry location;
wherein the parameter value shared by the plurality of tab pages comprises location information corresponding to the selected entry location.

9. The device for entering text based on an image of claim 8, wherein when implementing the step of automatically locating, according to the parameter value shared by the plurality of tag pages, a display page to a region corresponding to the selected entry location, the processor specifically implements the following step:
zooming in on the region corresponding to the selected entry location.

10. The device for entering text based on an image of claim 7, wherein when implementing the step of acquiring a recognition parameter corresponding to at least one region in an image, the processor specifically implements the following step:
dividing the image into regions automatically and recognizing text contents in the regions automatically divided.

11. The device for entering text based on an image of claim 10, wherein when implementing the step of recognizing text contents in the regions automatically divided, the processor specifically implements the following steps:
recognizing text contents in the regions automatically divided by using an OCR technology.

12. The device for entering text based on an image of claim 10, wherein when implementing the step of recognizing text contents in the regions automatically divided, the processor specifically implements the following step:
scoring the text contents recognized to identify recognition accuracy.

13. A computer readable storage medium, storing an executable instruction executed by a processor; wherein when the processor executes executable instruction, the processor executes a method according to claim 1.
